(19) United States
(12) Patent Application Publication
(10) Pub. No.: US 2007/0195215 A1
(43) Pub. Date: Aug. 23, 2007

(54) ELECTRO-OPTICAL DEVICE AND ELECTRONIC APPARATUS INCLUDING ELECTRO-OPTICAL DEVICE

(75) Inventor: Masao MURADE, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/618,029

(22) Filed: Dec. 29, 2006

(30) Foreign Application Priority Data
Feb. 22, 2006 (JP) 2006-045132

(51) Int. Cl. G02F 1/136

(52) U.S. Cl. 349/42

(57) ABSTRACT

An electro-optical device includes a substrate, a plurality of pixels provided on the substrate, a peripheral circuit for controlling the plurality of pixels, a clock signal line for supplying a clock signal to the peripheral circuit, and an inverted clock signal line for supplying an inverted clock signal to the peripheral circuit. The peripheral circuit is provided in a peripheral region on the substrate. The peripheral region is located in a periphery of a pixel region where the plurality of pixels is provided. The clock signal line and the inverted clock signal line are provided in the peripheral region on the substrate. The clock signal and the inverted clock signal have mutually opposite phases. The clock signal line and the inverted clock signal line are individually formed of conductive films located in mutually different layers via an inter-layer insulating film. The clock signal line and the inverted clock signal line at least partially overlap each other on the substrate.

### BACKGROUND

1. Technical Field

The invention relates to an electro-optical device, such as a liquid-crystal device, and to an electronic apparatus including the electro-optical device, such as a liquid-crystal projector.

2. Related Art

In an electro-optical device of this type, display electrodes such as pixel electrodes, and circuits such as a data-line driving circuit and a scanning-line driving circuit for driving the display electrodes are provided on a substrate, and a plurality of external-circuit connecting terminals is arrayed on the substrate along an edge of the substrate. Furthermore, a plurality of signal lines is provided on the substrate so as to connect the plurality of external-circuit connecting terminals to the circuits such as the scanning-line driving circuit and the data-line driving circuit. Typically, the data-line driving circuit is disposed along the edge of the substrate where the external-circuit connecting terminals are provided, and the scanning-line driving circuit is disposed along at least one of the two edges on either side of the edge along which the data-line driving circuit is disposed.

The circuits such as the data-line driving circuit receives a clock signal that serves as a base clock for operation and an inverted clock signal having an inverted phase compared with the phase of the clock signal from external circuits via the external-circuit connecting terminals and the signal lines.

The clock signal and inverted clock signal have an extremely high frequency to serve their purposes, so that the clock signal and inverted clock signal are likely to cause noises on image signals. Thus, usually, image signal lines for supplying image signals are connected from one side of the data-line driving circuit (e.g., closer to the left side), and clock signal lines for supplying the clock signals are connected from the other side of the data-line driving circuit (e.g., closer to the right side) Furthermore, in Japanese Patent No. 3,649,205, the assignee of this application proposed techniques for electromagnetically shielding image signal lines from clock signals as sources of high-frequency noises by providing a constant-voltage shield line between the image signal lines and clock signal lines.

However, when the clock signal lines and inverted clock signal lines and the image signal lines are connected from the opposite sides of the data-line driving circuit, the layout is restricted in view of relationships with other signal lines and circuits. This raises technical difficulty in reducing the size of the device. Furthermore, according to the techniques disclosed in Japanese Patent No. 3,649,205, noise caused by the clock signals could occur on the shield line, so that the noise caused by the clock signals could affect image signals via the shield line.

### SUMMARY

An advantage of some aspects of the invention is that it is possible to provide a small-sized electro-optical device in which negative effects of noises caused by clock signals on other signals such as image signals are suppressed, and to provide an electronic apparatus including the electro-optical device.

According to a first aspect of the invention, there is provided an electro-optical device. The electro-optical device includes a substrate, a plurality of pixels provided on the substrate, a peripheral circuit for controlling the plurality of pixels, a clock signal line for supplying a clock signal to the peripheral circuit, and an inverted clock signal line for supplying an inverted clock signal to the peripheral circuit. The peripheral circuit is provided in a peripheral region on the substrate. The peripheral region is located in a periphery of a pixel region where the plurality of pixels is provided. The clock signal line and the inverted clock signal line are provided in the peripheral region on the substrate. The clock signal and the inverted clock signal have mutually opposite phases. The clock signal line and the inverted clock signal line are individually formed of conductive films located in mutually different layers via an inter-layer insulating film. The clock signal line and the inverted clock signal line at least partially overlap each other on the substrate.

When the electro-optical device is in operation, for example, image signals, a clock signal, an inverted clock signal, various control signals, a power supply signal, and so forth are supplied from external circuits to signal lines and peripheral circuits via external-circuit connecting terminals. The signal lines include image signal lines, a clock signal line, and an inverted clock signal line, which are formed on the substrate. The peripheral circuits and the signal lines including the image signal lines, the clock signal line, and the inverted clock signal line are provided in a peripheral region provided in a periphery of a pixel region or pixel array region (also referred to as an “image display region”) in which the plurality of pixels is arranged to form a matrix on the substrate when viewed in plan. The “peripheral circuits” herein refer to various circuits formed on or attached to the substrate, such as a sampling circuit, or a scanning-line driving circuit or a data-line driving circuit for controlling or driving scanning lines or data lines electrically connected to the pixels. For example, the data-line driving circuit outputs sampling-circuit driving signals for driving the sampling circuit on the basis of a clock signal and an inverted clock signal for the data-line driving circuit. Image signals supplied to the image signal lines are sampled by the sampling circuit in, accordance with the sampling-circuit driving signals supplied from the data-line driving circuit, and the sampled image signals are supplied to the individual pixels. Furthermore, the scanning-line driving circuit supplies scanning signals to the individual pixels via the scanning lines on the basis of a clock signal and an inverted clock signal for the scanning-line driving circuit. The scanning lines are connected to the gates of pixel-switching thin-film transistors (hereinafter referred to as “pixel-switching TFTs”) or the like provided for the individual pixels, so that image signals are selectively supplied to pixel electrodes of the individual pixels in accordance with the scanning signals. Thus, i is possible to implement active-matrix driving, for example, by driving at individual pixels an electro-optical material, such as a liquid-crystal material, held between pixel electrodes and an opposing electrode. Without limitation to active-matrix driving, the electro-optical device may be driven in various manners, for example, by passive-matrix driving or segment driving.

Furthermore, in the electro-optical device, the clock signal line and the inverted clock signal line are individually formed of conductive films located in mutually different layers via an inter-layer insulating film, and at least partially overlap each other when viewed in plan on the substrate (i.e., when viewed in the direction of a normal line of the substrate). Preferably, the clock signal line and the inverted clock signal line substantially or practically fully overlap when viewed in plan on the substrate. Thus, with the overlapping region of the clock signal and the inverted clock signal line for respectively supplying the clock signal and the inverted clock signal having mutually opposite phases, clock noises (or electromagnetic noises) can be canceled. More specifically, when the clock signal line and the inverted clock signal line is formed in proximity to other signal lines, such as the power supply line or the image signal line, a clock noise could occur on the power supply signal, the image signals, or the like due to the clock signal or the inverted clock signal. In the electro-optical device according to the first aspect of the invention, the clock signal line and the inverted clock signal line carrying signals having mutually Opposite phases at least partially overlap each other when viewed in plan on the substrate. Thus, clock noises can be canceled on other signal lines formed in proximity. That is, clock noises caused by the clock signal line and the inverted clock signal line on other signal lines can be suppressed or prevented. Accordingly, occurrence of problems in operation's of the peripheral circuits can be suppressed or prevented. Particularly, electromagnetic noise caused on image signals, for example, boy the clock signal or the inverted clock signal for the data-line driving circuit, which has a higher frequency compared with the image signals, can be suppressed, so that the quality of image display can be improved.

Furthermore, since the clock signal line and the inverted clock signal line are individually formed of conductive films located in mutually different layers via an inter-layer insulating film, and at least partially over lap each other when viewed in plan on the substrates the area needed to from the clock signal line and the inverted clock signal line is smaller compared with a case where the clock signal line and the inverted clock signal line are formed of conductive films located in the same layer. Furthermore, since clock noises on other signal lines are suppressed or prevented, the clock signal line and the inverted clock signal line can be formed in proximity to lines for supplying signals having lower frequencies, such as the image signal lines. That is, the flexibility of layout of lines can be improved. Thus, while allocating a large area for the pixel region, it is possible to reduce the size of the substrate as a whole by reducing the size of the peripheral region, and therefore to reduce the size of the entire electro-optical device.

As described above, in the electro-optical device according to the first aspect of the invention, negative effects of noises caused by clock signals on other signals such as image signals can be suppressed, so that the quality of image display can be improved. Furthermore, the size of the substrate can be reduced, so that the size of the electro-optical apparatus can also be reduced.

The electro-optical device may further include a shielding film provided in the peripheral region, wherein the shielding film at least partially overlap the clock signal line and the inverted clock signal line in a layer between the layer of the clock signal line and the layer of the inverted clock signal line.

In this cases in the lamination structure on the substrate, the shielding film is provided between the clock signal line and the inverted clock signal line. More specifically, the clock signal line, the shielding film, and the inverted clock signal line are laminated via interlayer insulating films, in that order or in the opposite order. Furthermore, the shielding film is formed so as to at least partially overlap the clock signal line and the inverted clock signal line. Thus, the shielding film serves to suppress electromagnetic noises mutually caused on the clock signal line and the inverted clock signal line by the inverted clock signal and the clock signal. The “shielding film” herein refers to a film that functions as an electromagnetic shield, such as a conductive film. For example, the shielding film may be formed as a power supply line for supplying a power supply voltage to the peripheral circuits. Furthermore, clock noises caused on the shielding film by the clock signal line and the inverted clock signal line can be canceled. More specifically, since the clock signal and the inverted clock signal have mutually opposite phases and the clock signal line and the inverted clock signal line are provided on opposite sides of the shielding film in the lamination structure on the substrate, clock noises on the shielding film can be suppressed or prevented. Accordingly, clock noises or similar negative effects caused by the clock signal line or the inverted clock signal line via the shielding film on other signal lines, such as the image signal lines, can be suppressed or prevented.

In the case where the shielding film is provided, the shielding film may be formed as a constant-voltage line for supplying a constant voltage.

In this case, since the constant-voltage line functions as the shielding film, it is possible to suppress electromagnetic interference between the clock signal and the inverted clock signal and to thereby suppress or prevent problems in operations of the peripheral circuits without increasing the complexity of manufacturing processes. Furthermore, since clock noises on the constant-voltage line caused by the clock signal line and the inverted clock signal line are canceled, so that variation or fluctuation of the potential of the constant-voltage line can be prevented. Thus, negative effects caused via the constant-voltage line on other signal lines, such as the image signal lines, can be suppressed or prevented. Alternatively, the shielding film may be a predetermined-voltage line for supplying a predetermined voltage signal in which the voltage takes on predetermined voltages at regular cycles, such as a predetermined voltage signal in which the voltage is toggled at regular cycles. Also in this case, since the voltage is constant when considered over a predetermined period, a considerable effect of suppressing electromagnetic interference is achieved similarly to the case described above.

When the shielding film is a constant-voltage line, the constant-voltage line may be formed as a power supply line for supplying a power supplying voltage to the peripheral circuit.

In this case, since the power supply line functions as the shielding film, it is possible to suppress electromagnetic interference between the clock signal and the inverted clock signal without increasing the complexity of manufacturing processes. Furthermore, negative effects caused on other signal lines, such as the image signal lines, can be suppressed or prevented.

Furthermore, when the shielding film is a constant-voltage line, the electro-optical device may further include an opposing electrode, the opposing electrode opposing pixel electrodes in the pixels, and the constant-voltage line may be an opposing-electrode-voltage line for supplying an opposing-electrode voltage to the opposing electrode.

In this case, the opposing-electrode-voltage line functions as the shielding film. Thus, it is possible to suppress electromagnetic interference between the clock signal and the inverted clock signal without increasing the complexity of manufacturing processes. Furthermore, negative effects caused on other signal lines, such as the image signal lines, can be suppressed or prevented.

Furthermore, when the shielding film is a constant-voltage line, the constant-voltage line, when viewed in plan on the substrate, preferably has a width that is at least partially larger than either one of or both a width of the clock signal line and a width of the inverted clock signal line.

In this case, since the constant-voltage line, when viewed in plan on the substrate, preferably has a width that is at least partially larger than either one of or both a width of the clock signal line and a width of the inverted clock signal line, electromagnetic interference between he clock signal line and the inverted clock signal line is suppressed more certainly. That is, the performance of the constant-voltage line as the shielding film is improved. Furthermore, the wider line width serves to reduce the resistance of the constant-voltage line. Thus, a constant voltage signal or a constant power supply voltage can be supplied stably to the peripheral circuit via the constant-voltage line.

Furthermore, when the shielding film is provided, preferably, the clock signal line and the inverted clock signal line, when viewed in plan on the substrate, are formed so as to have equivalent widths and so as to overlap each other.

In this case, the clock signal line and the inverted clock signal line are formed so as to have equivalent widths when viewed in plan on the substrate. That is, the widths of the clock signal line and the inverted clock signal line are substantially the same or practically the same. Furthermore, the clock signal line and the inverted clock signal line are formed so as to overlap each other. That is, the clock signal line and the inverted clock signal line substantially or practically fully overlap each other when viewed in plan on the substrate. Thus, noises caused by the clock signal line and the inverted clock signal line are canceled more certainly on the shielding film. Accordingly, clock noises or similar negative effects caused via the shielding film on other signal lines, such as the image signal lines, are suppressed or prevented more certainly. Furthermore, the clock signal line and the inverted clock signal line can be formed in an area of a size substantially the same as the size of an area needed to form, one clock signal line on the substrate. This serves to reduce the size of the substrate.

Furthermore, when the shielding film is provided, preferably, either widths or lengths or both widths and lengths of the clock signal line and the inverted clock signal line are adjusted to keep a difference between a capacitance of a first capacitor and a capacitance of a second capacitor small, the first capacitor being formed of a lamination of the clock signal line, a first inter-layer insulating film, and the shielding film, and the second capacitor being formed of a lamination of the inverted clock signal line, a second inter-layer insulating film, and the shielding film.

In this case, the clock signal line and the inverted signal line are formed so that the capacitance of the first capacitor formed of the lamination of the clock signal line, the first inter-layer insulating film, and the shielding film is substantially or practically the same as the capacitance of the second capacitor formed of the lamination of the inverted clock signal line, the second inter-layer insulating film, and the shielding film. Thus, the level of noise caused by the clock signal line on the shielding film via the first capacitor substantially or practically fully matches the level of noise caused by the inverted clock signal line on the shielding film via the second capacitor. Accordingly, noises caused by the clock signal line and the inverted clock signal line and having mutually opposite phases are canceled more certainly on the shielding film.

Furthermore, when the shielding film is provided, the electro-optical device may further include a plurality of external-circuit connecting terminals arrayed in the peripheral region on the substrate, the external-circuit connecting terminals being electrically connected respectively to the clock signal line, the inverted clock signal line, and the shielding film. The external-circuit connecting terminal electrically connected to the shielding film may be located between the external-circuit connecting terminals electrically connected respectively to the clock signal line and the inverted clock signal line when viewed in plan on the substrate.

In this case, the shielding film can also function in the region where the clock signal line and the inverted clock signal line are electrically connected to the external-circuit connecting terminals. Accordingly, electromagnetic interference between the clock signal and the inverted clock signal is suppressed more certainly. Furthermore, negative effects caused via the shielding film on other signal lines, such as the image signal lines, is suppressed or prevented more certainly.

Furthermore, when the shielding film is provided, the electro-optical device according may further include a plurality of data lines and a plurality of scanning lines arranged to intersect each other in the pixel region, with the pixels provided in association with intersections of the data lines and the scanning lines. The pixels may include storage capacitors on the substrate, each of the storage capacitors being formed of a lamination of a lower electrode, a dielectric film, and an upper electrode in that order. Furthermore, each of the clock signal line, the inverted clock signal line, and the shielding film may be formed of the same film as one of conductive films respectively forming the lower electrodes and the upper electrodes.

In this case, each of the clock signal line, the inverted clock signal line, and the shielding film is formed of the same film as one of the conductive films respectively forming the data line, the lower electrodes, and the upper electrodes. The “same film” herein refers to films formed on the same occasion in manufacturing processes, and so that the films are of the same type. The “same film” does not require being a single continuous film, and it suffices to be film segments formed out of a single film. Thus, each of the clock signal line, the inverted clock signal line, and the shielding film can be formed on the same occasion as one of the conductive films respectively forming the data line, the lower electrodes, and the upper electrodes. That is, it is possible to form the clock signal line, the inverted clock signal line, and the shielding line from a plurality of conductive films without increasing complexity of the manufacturing processes.

The storage capacitors serve to improve the performance of maintaining voltages at the pixel electrodes of the pixels. This serves to improve contrast of display.

Furthermore, when the shielding film is provided, the image signal lines may be formed of the same film as the shielding film.

In this case, since the image signal lines are formed of the same film as the shielding film, for example, even when the image signal lines are formed in proximity to the clock signal line and the inverted clock signal line, similarly to the shielding film, noise caused by the clock signal line and the inverted clock signal line can be canceled also on the image signal lines. Accordingly, clock noises that could occur on the image signal lines due to the clock signal line and the inverted clock signal line can be suppressed or prevented. This serves to improve the quality of display.

According to a second aspect of the invention, there is provided an electronic apparatus including the electro-optical device described above.

Since the electronic apparatus includes the electro-optical device described above, various electronic apparatuses with improved qualities of display can be implemented. Examples of such electronic apparatuses include projection displays, cellular phones, electronic notebooks, word processors, view-finder or direct-view video tape recorders, workstations, video phones, point-of-sales (POS) terminals, and touch panels. Furthermore, it is possible to implement an electrophoresis device, such as an electronic paper, as an electronic apparatus according to the second aspect.

Other operations and advantages of the invention will become apparent from the following description of embodiments.

### BRIEF DESCRIPTION OF THE DRAWINGS

The invention will be described with reference to the accompanying drawings, wherein like numbers reference like elements.

FIG. 1 is a plan view showing the overall configuration of a liquid-crystal device according to a first embodiment.

FIG. 2 is a sectional view taken along line II-II in FIG. 1.

FIG. 3 is an equivalent circuit diagram of a plurality of pixel portions.

FIG. 4 is a plan view showing a partial configuration (lower layers) of pixel portions.

FIG. 5 is a plan view showing a partial configuration (upper layers) of pixel portions.

FIG. 6 is a sectional view taken along line VI-VI with the configurations shown in FIGS. 4 and 5 laminated with each other.

FIG. 7 is a diagram showing the electrical configuration of a data-line driving circuit, a sampling circuit, and signal lines

FIG. 8 is a sectional view taken along a line VIII-VIII in FIG. 7.

FIG. 9 is a sectional view showing a first modification, corresponding to FIG. 8 showing the first embodiment.

FIG. 10 is a diagram showing a second embodiment, corresponding to FIG. 7 showing the first embodiment.

FIG. 11 is a sectional view taken along a line XI-XI in FIG. 10.

FIG. 12 is a layout diagram of an X-side clock signal line, an X-side inverted clock signal line, and a power supply lines in the proximity of external-circuit connecting terminals.

FIG. 13 is a sectional view taken along a line XIII-XIII in FIG. 12.

FIG. 14 is a plan view showing the configuration of a projector, which is an example of an electronic apparatus including an electro-optical device.

### DESCRIPTION OF EXEMPLARY EMBODIMENTS

Now, embodiments of the invention will be described with reference to the drawings. The embodiments will be described below in toe context of TFT active-matrix liquid-crystal devices including driving circuits, which serve as examples of electro-optical devices according to the invention.

### First Embodiment

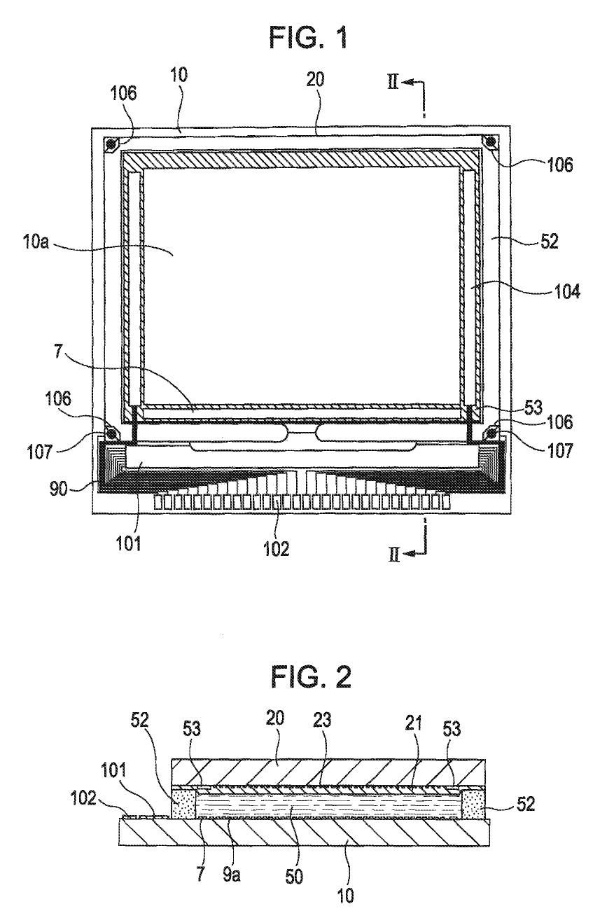

A liquid-crystal device according to a first embodiment will be described with reference to FIGS. 1 to 9.

First, the overall configuration of the liquid-crystal device according to the first embodiment will be described with reference to FIGS. 1 and 2. FIG. 1 is a plan view snowing the configuration of the liquid-crystal device according to this embodiment, and FIG. 2 is a sectional view taken along a line II-II in FIG. 1.

Referring to FIGS. 1 and 2, in the liquid-crystal device according to this embodiment, a TFT-array substrate 10 and an opposing substrate are provided opposing each other. Between the TFT-array substrate 10 and the opposing substrate 20, a liquid-crystal layer 50 is provided. Furthermore, the TFT-array substrate 10 and the opposing substrate 20 are bonded with each other by a sealing agent 52 provided in a sealing region in the periphery of an image display region 10a, which is an example of a “pixel region” in the invention.

Referring to FIG. 1, inside and in parallel to the sealing region where the sealing agent 52 is provided, a frame-shaped light-blocking film 53 defining a frame of the image display region 10a is provided on the opposing substrate 20. In the peripheral region, a data-line driving circuit 101 and external-circuit connecting terminals 102 are provided along one edge of the TFT-array substrate 10 in a region outside the sealing region where the sealing agent 52 is provided. Furthermore, in a region inside the sealing region along the one edge, a sampling circuit 7 is provided so as to be covered by the frame-shaped light-blocking film 53. Furthermore, in a region inside the sealing region along the two edges adjacent to the one edge, a scanning-line driving circuit 104 is provided so as to be covered by the frame-shaped light-blocking film 53. Furthermore, on the TFT-array substrate 10, in regions opposing the four corners of the opposing substrate 20, vertical conduction terminals 106 for providing connections between the TFT-array substrate 10 and the opposing substrate 20 via vertical conductors 107 are provided. This allows providing electrical connections between the TFT-array substrate 10 and the opposing substrate 20. The data-line driving circuit 101, the sampling circuit 7, and the scanning-line driving circuit 104 are examples of “peripheral circuits” in the invention.

On the TFT-array substrate 10, signal lines 90 for electrically connecting the external-circuit connecting terminals 102 with the data-line driving circuit 101, the scanning-line driving circuit 104, the vertical conduction terminals 106, and so forth are formed. As will be described later, the signal lines include video signal lines, a clock signal line, an inverted clock signal line, a power supply line, and so forth.

Referring to FIG. 2, on the TFT-array substrate 10, a lamination structure including pixel-switching TFTs as driving elements and lines such as scanning lines and data lines is formed. In the image display region 10a, a plurality of pixel electrodes 9a is provided in a layer above the pixel-switching TFTs and lines such as scanning lines and data lines. On a surface of the opposing substrate 20, opposing the TFT-array substrate 10, a light-blocking film 23 is formed. On the light-blocking film 23, an opposing electrode 21 opposing the pixel electrodes 9a is formed of a transparent material, such as indium tin oxide (ITO).

On the TFT-array substrate 10, in addition to the data-line driving circuit 101 and the scanning-line driving circuit 104, for example, a testing circuit, a testing pattern, or the like for testing the quality of the liquid-crystal device or checking defects during manufacturing or at the time of shipping may be formed.

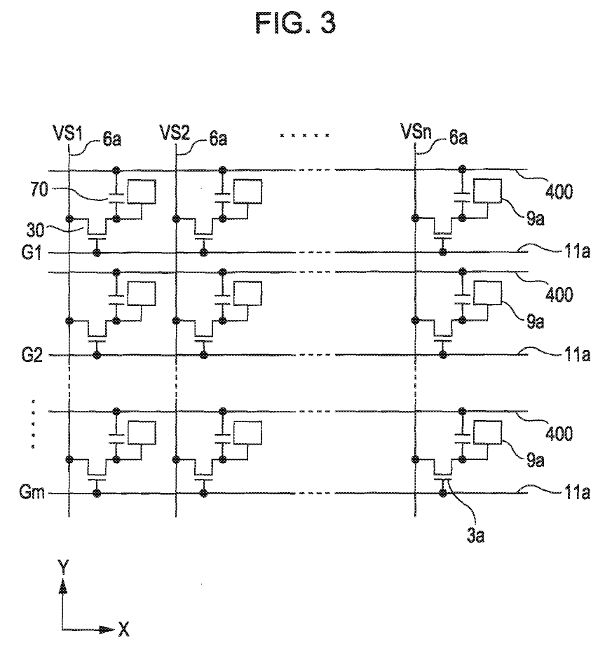

Next, the electrical configuration of pixel portions in the liquid-crystal device according to this embodiment will be described with reference to FIG. 3. FIG. 3 is a diagram showing an equivalent circuit of various elements, lines, and so forth in a plurality of pixel portions arranged to form a matrix and constituting the image display region of the liquid-crystal device.

### Principles of the Configuration of the Pixel Portions

Referring to FIG. 3, in each of the plurality of pixel portions arranged to from a matrix and constituting the image display region in the liquid-crystal device according to this embodiment, a pixel electrode 9a and a TFT 30 for controlling switching of the pixel electrode 9a are formed, and a data line 6a for supplying a video signal is electrically connected to the source of the TFT 30. Video signals VS1, VS2, . . . , VSn that are written to the data lines 6a may be supplied sequentially line by line, or in groups to sets of a plurality of data lines 6a adjacent to each other.

To the gate of the TFT 30, a scanning line 11a is electrically connected. Pulses of scanning signals G1, G2, . . . , and Gm are applied to the scanning lines 11a sequentially line by line. The pixel electrode 9a is electrically connected to the drain of the TFT 30, and switches on the TFT 30 as a switching element for a predetermined period. Thus, the video signals VS1, VS2, . . . , VSn supplied from the data lines 6a are written at specific timings.

The video signals VS1, VS2, . . . , VSn having certain levels, written to the liquid crystal via the pixel electrodes 9a, are maintained for a predetermined period between the pixel electrodes 9a and the op posing electrode 21 formed on the opposing substrate 20. The liquid crystal changes the orientation or order of its molecules according to the level of a voltage applied thereto, thereby modulating light so that various tones can be displayed. In the case of normally white mode, the transmission rate of incident light decreases in accordance with voltages applied to individual pixels. On the other hand, in the case of normally black mode, the transmission rate of incident line increases in accordance with voltages applied to individual pixels. Thus, as a whole, light having contrast in accordance with the video signals is output from the liquid-crystal device.

In order to prevent leakage of the video signals maintained, a storage capacitor 70 is attached in parallel to the liquid-crystal capacitor formed between the pixel electrode 9a and the opposing electrode 21. One electrode of the storage capacitor 70 is connected to the drain of the TFT 30 in parallel to the pixel electrode 9a, and the other electrode is connected to a constant-voltage capacitor line 400 so that it is at a fixed potential.

### Specific Configuration of the Pixel Portions

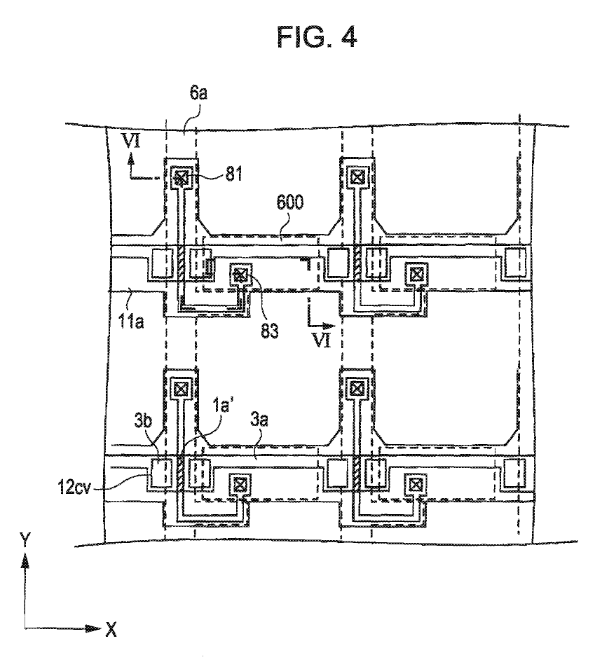

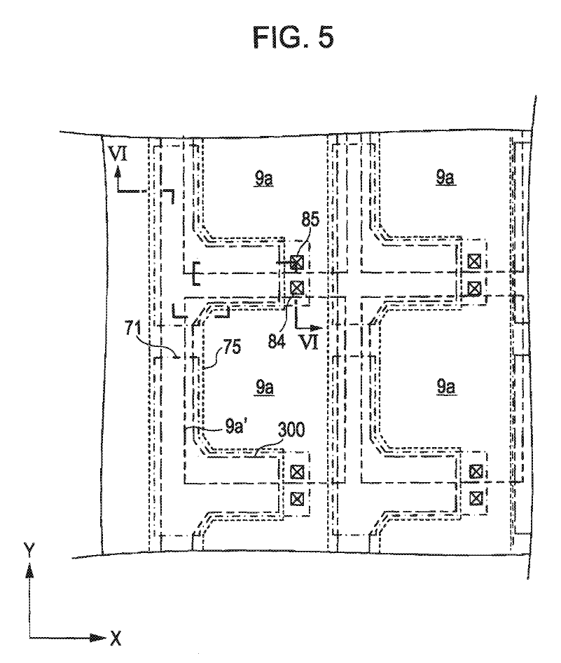

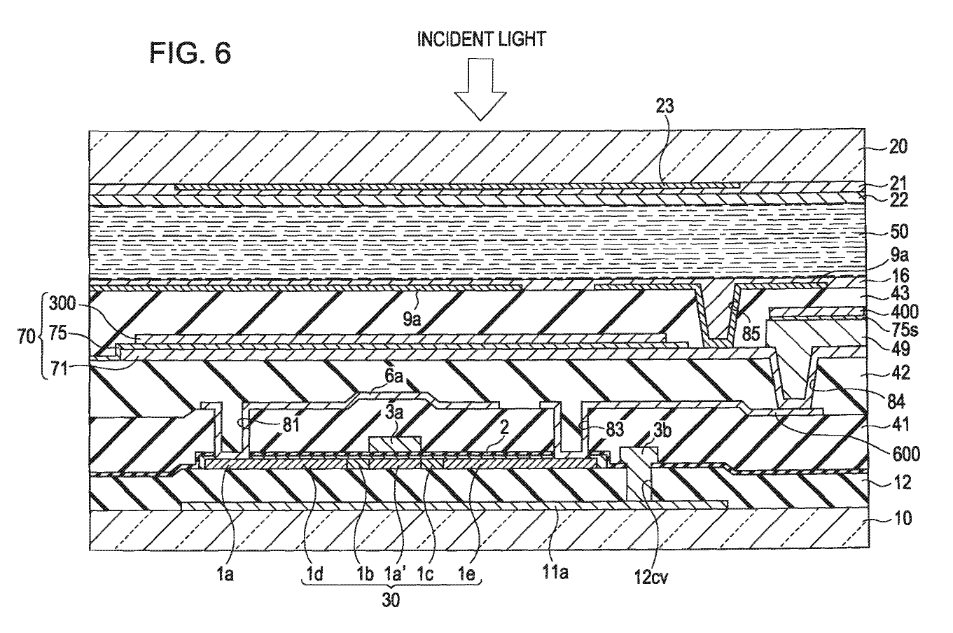

Next, a specific configuration of the pixel portions for implementing the operation described above will be described with reference to FIGS. 4 to 6. FIGS. 4 and 5 are plan views showing partial configurations of the pixel portions on the TFT-array substrate 10. More specifically, FIG. 4 shows lower layers and FIG. 5 shows upper layers of a lamination structure described later. FIG. 6 is a sectional view, taken along a line VI-VI, of a structure formed by laminating the upper layers and lower layers shown in FIGS. 4 and 5. In FIG. 6, individual layers and portions are shown in different scales so that the individual layers and portions are shown in sizes recognizable in the figures.

Referring to FIGS. 4 to 6, the circuit elements of the pixel portions described above are provided by in the form of laminated conductive films on the TFT-array substrate 10. The TFT-array substrate 10 is, for example, a glass substrate, a quartz substrate, a silicon-on-insulator (SOI) substrate, or a semiconductor substrate. The TFT-array substrate 10 is opposed to the opposing substrate 20. The opposing substrate 20 is, for example, a glass substrate or a quartz substrate. The circuit elements are formed of a first layer including the scanning lines 11a, a second layer including the TFTs 30, a third layer including the data lines 6a, a fourth layer including the storage capacitors 70, and a fifth layer including the pixel electrodes 9a, in that order from the bottom. Furthermore, a base insulating film 12 is provided between the first and second layers, an inter-layer insulating film 41 is provided between the second and third layers, an interlayer insulating film 42 is provided between the third and fourth layers, and an inter-layer insulating film 43 is provided between the fourth and fifth layers, thereby preventing short circuiting between the elements described above. Of these layers, FIG. 4 shows the first to third layers as lower layers, and FIG. 5 shows the fourth and fifth layers as upper layers.

### Configuration of the First Layer Including the Scanning Lines

The first layer includes the scanning lines 11a. Each of the scanning lines 11a is pattered so as to have a main portion extending in an X direction in FIG. 4 and a protruding portion extending in a Y direction in FIG. 4. The Y direction is a direction in which the data lines 6a extend. The scanning lines 11a are formed of conductive polysilicon. Instead of conductive polysilicon, the scanning lines 11a may be formed of, for example, an elementary high-melting metal, such as titanium (Ti), chromium (Cr), tungsten (W), tantalum (Ta), or molybdenum (Mo), an alloy, metal silicide, or metal polysilicide including at least one of such high-melting metals, or a lamination of these materials.

### Configuration of the Second Layer Including the TFTs

The second layer includes the TFTs 30. Each of the TFTs 30 has, for example, a lightly doped drain (LDD) structure. More specifically, the TFT 30 has a gate electrode 3a, a semiconductor layer 1a, and an insulating film 2 including a gate insulating film for insulating the gate electrode 3a and the semiconductor layer 1a from each other. The gate electrode 3a is formed of, for example, conductive polysilicon. The semiconductor layer 1a is formed of, for example, polysilicon. The semiconductor layer 1a includes a channel region 1a′, a lightly doped source region 1b, lightly doped drain region 1c, a heavily doped source region 1d, and a heavily doped drain region 1e. Although the LDD structure is preferred for the TFT 30, alternatively, the TFT 30 may have an offset structure in which regions that are not doped with impurities are provided instead of the lightly doped source region 1b and lightly doped drain region 1c. Yet alternatively, the TFT 30 may be formed by self-alignment, i.e., a heavily doped source region and a heavily doped drain region may be formed by heavily doping these regions with impurities using the gate electrode 3a as a mask.

The gate electrode 3a of the TFT 30, at a portion 3b thereof, is electrically connected to the scanning line 11a via a contact hole 12cv formed in the base insulating film 12. The base insulating film 12 is formed of, for example, silicon oxide.

Although the TFTs 30 in this embodiment are top-gate TFTs, alternatively, bottom-gate TFTs may be used.

### Configuration of the Third Layer Including the Data Lines

The third layer includes the data lines 6a and relaying layers 600.

Each of the data lines 6a is formed of a film including three layers of aluminum, titanium nitride, and silicon nitride. The data line 6a is formed so as to partially cover the channel region 1a′ of the TFT 30. Furthermore, the data line 6a is electrically connected to the heavily doped source region 1d of the TFT 30 via a contact hole 81 penetrating the inter-layer insulating film 41.

The relaying layers 600 are formed out of the same film as the data lines 6a. As shown in FIG. 4, the relaying layers 600 and the data lines 6a are formed as separated segments. Furthermore, each of the relaying layers 600 is electrically connected to the heavily doped drain region 1e of the associated TFT 30 via a contact hole 83 penetrating the inter-layer insulating film 41.

The inter-layer insulating film 41 is formed of, for example, non-silicate glass (NSG). Alternatively, the inter-layer insulating film 41 may be formed of, for example, silicate glass such as phosphosilicate glass (PSG), borosilicate glass (BSG), or borophosphosilicate glass (BPSG), silicon nitride, or silicon oxide.

### Configuration of the Fourth Layer Including the Storage Capacitors

The fourth layer includes the storage capacitors 70. Each of the storage capacitors 70 is formed of a capacitor electrode 300 and a lower electrode 71 opposing each other via a dielectric film 75. The capacitor electrode 300 is formed as a part of the capacitor line 400, so that the capacitor electrode 300 is electrically connected to the capacitor line 400 (refer to FIG. 3). The capacitor electrode 300 is an example of an “upper electrodes” in the invention, and the lower electrode 71 is an example of a “lower electrode” in the invention. The extending portion of the lower electrode 71 is electrically connected to the relaying layer 600 via a contact hole 84 penetrating the second inter-layer insulating film 42.

The capacitor electrode 300 and the lower electrode 71 are formed of, for example, an elementary high-melting metal, such as Ti, Cr, W, Ta, or Mo, an alloy, metal silicide, or metal polysilicide including at least one of such high-melting metals, or a lamination of these materials. Preferably, the capacitor electrode 300 is formed of tungsten silicide.

As shown in FIG. 5, the dielectric film 75 is formed in a non-opening region located between opening regions of individual pixels when viewed in plan on the TFT-array substrate 10. The dielectric film 75 is formed of, for example, silicon nitride. Alternatively, the dielectric film 75 may be a single-layer film or multi-layer film of hafnium oxide (HfO₂), alumina (Al₂O₃), tantalum oxide (Ta₂O₅), or the like.

The second inter-layer insulating film 42 is formed of, for example, NSG. Alternatively, the second inter-layer insulating film 42 may be formed of, for example, silicate glass such as PSG, BSG, or BPSG, silicon nitride, or silicon oxide. The surface of the second inter-layer insulating film 42 is flattened by chemical mechanical polishing (CMP) or other types of polishing, spin coating, or filling of recessed portions. Thus, projected or recessed portions attributable to the above-described elements on the lower layer side are removed so that the surface of the second inter-layer insulating layer 42 is flat. Such flattening may be applied to the surfaces of other inter-layer insulating films.

### Configuration of the Fifth Layer Including the Pixel Electrodes

The inter-layer insulating film 43 is formed over the entire fourth layer, and the pixel electrodes 9a are formed as a fifth layer on the inter-layer insulating film 43. The inter-layer insulating film 43 is formed of, for example, NSG. Alternatively, the inter-layer insulating film 43 may be formed of, for example, silicate glass such as PSG, BSG, or BPSG, silicon nitride, or silicon oxide. Similarly to the inter-layer insulating film 42, the surface of the inter-layer insulating film 43 is flattened, for example, by CMP.

The pixel electrodes 9a (defined by broken lines 9a′in FIG. 5) are located in individual pixel portions defined horizontally and vertically to form a matrix, and the data lines 6a and the scanning lines 11a are formed along the horizontal and vertical boundaries to form a lattice (refer to FIGS. 4 and 5). The pixel electrodes 9a are formed of transparent conductive films composed of, for example, ITO.

Each of the pixel electrodes 9a is electrically connected to the extending portion of the associated lower electrode 71 via a contact hole 85 penetrating the inter-layer insulating film 43 (refer to FIG. 6). That is, the potential of the lower electrode 71 is the same as the pixel potential. Furthermore, as described earlier, the extending portion of the lower electrode 71 is electrically connected to the relaying layer 600 via the contact hole 84, and the relaying layer 600 is electrically connected to the heavily doped drain region 1e of the TFT 30 via the contact hole 83. That is, the pixel electrode 9a is connected to the heavily doped drain region 1e of the TFT 30 via the relaying layer 600 and the extending portion of the capacitor electrode 300. On the upper side of the pixel electrodes 9a, an oriented film processed by rubbing or the like so as to have a specific orientation is provided.

This concludes the description of the configuration of the pixel portions on the side of the TFT-array substrate 10.

On the other hand, on the entire opposing surface of the opposing substrate 20, the opposing electrode 21 is provided. Furthermore, on the opposing electrode (under the opposing electrode 21 as viewed in FIG. 6), an oriented film 22 is provided. Similarly to the pixel electrodes 9a, the opposing electrode 21 is formed of a transparent conductive material, for example, ITO. Between the opposing substrate 20 and the opposing electrode 21, in order to prevent occurrence of optical leakage currents in the TFTs 30 or similar problems, the light-blocking film 23 is provided so as to cover at least regions squarely opposing the TFTs 30.

Between the TFT-array substrate 10 and the opposing substrate 20 configured as described above, the liquid-crystal layer 50 is provided. The liquid-crystal layer 50 is formed by encapsulating liquid crystal in a space formed by sealing the peripheries of the TFT-array substrate 10 and the opposing substrate 20 by a sealing agent. When no electric field is applied between the pixel electrodes 9a and the opposing electrode 21, the liquid-borophosphosilicate glass crystal layer 50 exhibits a predetermined orientation determined by the oriented films 16 and 22 processed to have specific orientations by rubbing or the like.

The configuration of the pixel portion described above is common to all the pixel portions, as showman in FIGS. 4 to 5. In the image display region 10a (refer to FIG. 1) described earlier, pixel portions configured as described above are formed at regular intervals.

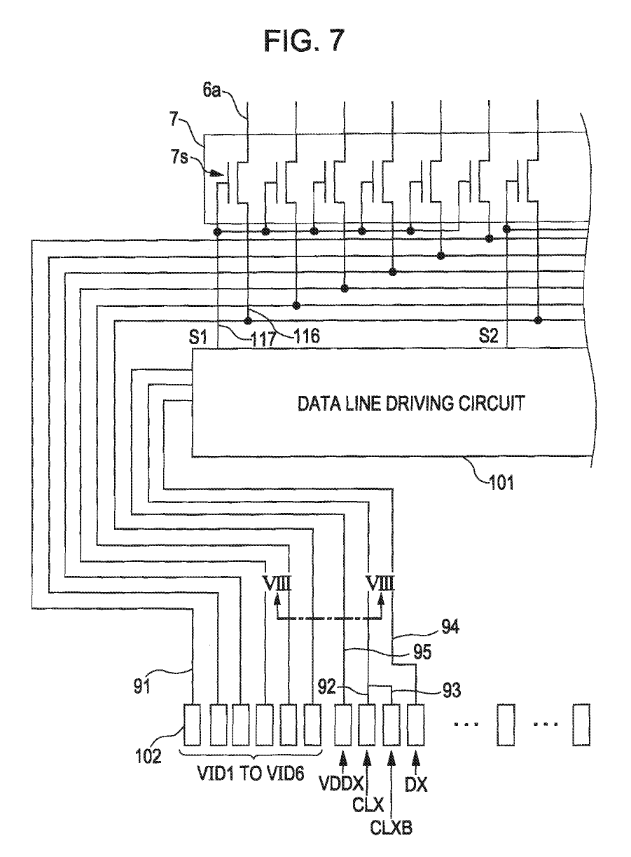

Next, the circuit configurations of the data-line driving circuit and the sampling circuit, and electrical connections of signal lines including video signal lines, X-side clock signal lines, and a power supply line will be described with reference to FIG. 7. FIG. 7 is a diagram snowing the circuit configurations of the data-line driving circuit and the sampling circuit, and electrical connections of signal lines.

Referring to FIG. 7, in the peripheral region on the TFT-array substrate 10, the data-line driving circuit 101, the sampling circuit 7, and the external-circuit connecting terminals 102 are provided, and a plurality of signal lines 90 including video signal lines 91, an X-side clock signal line 92, an X-side inverted clock signal line 93, a shift-register start signal line 94, and a power supply line 95 is provided.

The data-line driving circuit 101 receives an X-side clock signal CLX, an X-side inverted clock signal CLXB, and a shift-register start signal DX from external circuits via the external-circuit connecting terminals 102 and via the X-side clock signal line 92, the X-side inverted clock signal line 93, and the shift-register start signal line 94, respectively. The X-side clock signal CLX and the X-side inverted clock signal CLXB are signals having a predetermined period, and these signals have mutually inverted phases, i.e., mutually opposite phases.

The data-line driving circuit 101 includes shift registers, and logical circuits for shaping signals transferred from the shift registers. The data-line driving circuit 101 is configured to output sampling-circuit driving signals Si (i=1, . . . , n) for driving the sampling circuit 7 on the basis of the X-side clock signal CLX, the X-side inverted clock signal CLXB, and the shift-register start signal DX.

When the liquid-crystal device is in operation, the data-line driving circuit 101 receives a power supply voltage VDDX from an external circuit via one of the external-circuit connecting terminals 102 and the power supply line 95 as an example of a “constant-voltage line” in the invention, whereby transistors in the data-line driving circuit 101 are driven.

Referring to FIG. 7, branch lines 116 branch from the individual video signal lines 91. Each of the branch lines 116 is connected to the source of an associated sampling switch 78 implemented by a TFT or the like in the sampling circuit 7. Furthermore, sampling-circuit driving signal lines 117 extending from the data-line driving circuit 101 are connected to the gates of the sampling switches 73. Thus, when the liquid-crystal device is in operation, video signals VID1 to VID6 applied to the external-circuit connecting terminals 102 for the video signals VID1 to VID6 are fed to the sampling circuit 7 via the branch lines 116 branching from the video signal lines 91, and are sampled in the sampling circuit 7 at timings corresponding to the sampling-circuit driving signals Si supplied from the data-line driving circuit 101 via the sampling-circuit driving signal lines 117. Then, the sampled video signals are fed to the individual data lines 6a.

The video signals supplied to the sampling circuit 7 via the branch lines 116 branching from the video signal lines 91 may be supplied sequentially line by line. In this embodiment, however, the video signals are converted from serial to parallel by six phases, and the video signals are fed in groups to sets of six data lines 6a. The number of phases of video signals for serial-to-parallel conversion is not limited to six phases, and may be, for example, nine phases, twelve phases, or twenty-four phases. Also in this case, the video signals are fed in groups to sets of a corresponding number of data lines 6a.

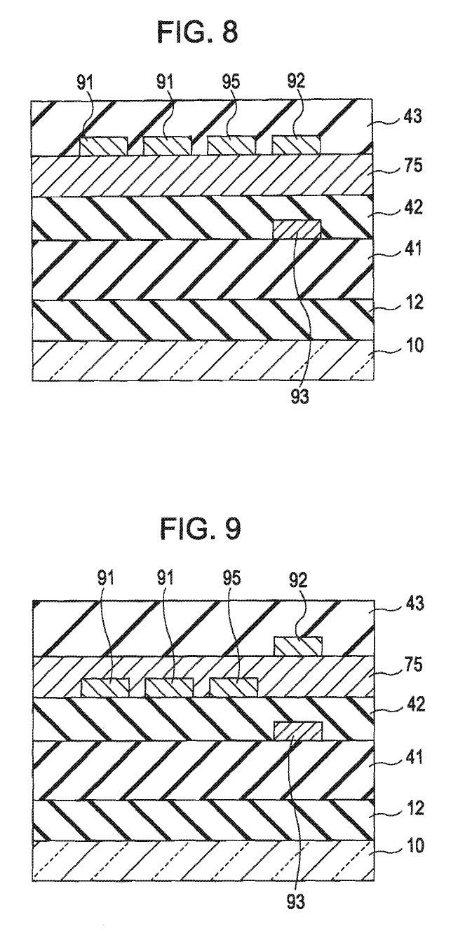

Next, the X-side clock signal line and the X-side inverted clock signal line in the liquid-crystal device according to this embodiment will be described in detail with reference to FIGS. 7 and 8. FIG. 8 is a sectional view taken along a line VIII-VIII in FIG. 7. In FIG. 8, individual layers and portions are shown in different scales so that the layers and parts are shown in sizes recognizable in the figure.

In FIG. 7, the signal lines 90 including the video signal lines 91, the X-side clock signal line 92, the X-side inverted clock signal line 93, the shift-register start signal line 94, and the power supply line 95 are provided to connect the data-line driving circuit 101 to the respectively associated external-circuit connecting terminals 102. In the peripheral region on the TFT-array substrate 10, as the signal lines 90, lines for providing a Y-side clock signal, a Y-side inverted clock signal, various control signals, a power supply signal, and so forth for driving peripheral circuits such as the data-line driving circuit 101 and the scanning-line driving circuit 104 are also provided.

As shown in FIGS. 7 and 8, in this embodiment, the X-side clock signal line 92 and the X-side inverted clock signal line 93 are formed out of conductive films located in different layers via the dielectric film 75 and the inter-layer insulating film 42, and partially overlap each other when viewed in plan on the TFT-array substrate 10 (i.e., when viewed in the direction of a normal line of the TFT-array substrate 10). Thus, with the overlapping region of the X-side clock signal line 92 and the X-side inverted clock signal line 93 that respectively supply the X-side clock signal CLX and the X-side inverted clock signal CLXB having mutually opposite phases, clock noises (or electromagnetic noises) having mutually opposite phases can be canceled. More specifically, when the X-side clock signal line 92 and the X-side inverted clock signal line 93 are located in proximity to the power supply line 95 or the video signal lines 91, a clock noise could occur in the power supply signal VDDX or the video signals VID due to the X-side clock signal CLX or the X-side inverted clock signal CLXB. According to this embodiment, the X-side clock signal line 92 and the X-side inverted clock signal line 93 having mutually opposite phases at least partially overlap each other when viewed in plan on the TFT-array substrate 10. Thus, clock noises cancel each other on the power supply line 95 and the video signal lines 91 (or other signal lines such as the shift-register start signal line 94). That is, clock noises caused by the X-side clock signal line 92 and the X-side inverted clock signal line 93 on the other signal lines 90 can be suppressed. Accordingly, occurrence of problems in the operations of the peripheral circuits such as the data-line driving circuit 101 can be suppressed. Particularly, electromagnetic noises on video signals supplied to the video signal lines 91 are suppressed, so that the quality of image display can be improved. Preferably, the X-side clock signal line 92 and the X-side inverted clock signal line 93 are formed so as to substantially or practically fully overlap each other when viewed in plan on the TFT-array substrate 10. In this case, clock noises are more certainly suppressed or prevented through canceling. However, even when the region where the X-side clock signal line 92 and the X-side inverted clock signal line 93 overlap each other is relatively small, a considerable effect of suppressing or preventing clock noises can be achieved.

Furthermore, as shown in FIGS. 7 and 8, in this embodiment, the X-side clock signal line 92 and the X-side inverted clock signal line 93 are formed of conductive films located in mutually different layers via the dielectric film 75 and the inter-layer insulating film 42, and partially overlap each other when viewed in plan on the TFT-array substrate 10. Thus, compared with a case where the X-side clock signal line 92 and the X-side inverted clock signal line 93 are formed of conductive films located in the same layer, the size of a region on the substrate needed to form the X-side clock signal line 92 and the X-side inverted clock signal line 93 can be reduced. Furthermore, since clock noises on other signal lines 90 are suppressed as described above, the X-side clock signal line 92 and the X-side inverted clock signal line 93 can be disposed in proximity to signal lines 90 on which signals with relatively low frequencies flow, such as the video signal lines 91. That is, the flexibility of layout of lines can be improved. Thus, while allocating a large area for the image display region 10a, it is possible to reduce the size of the TFT-array substrate 10 as a whole by reducing the size of the peripheral region, and therefore to reduce the size of the entire liquid-crystal device.

Furthermore, as shown in FIG. 8, the X-side clock signal line 92 is formed out of the same film as the capacitor electrodes 300 (refer to FIG. 6), and the X-side inverted clock signal line 93 is formed out of the same film as the data lines 6a (refer to FIG. 6) That is, in the manufacturing processes, the X-side clock signal line 92 is formed on the same occasion as the capacitor electrodes 300 out of the same film, and the X-side inverted clock signal line 93 is formed on the same occasion as the data lines 6a out of the same film. Thus, the X-side clock signal line 92 and the X-side inverted clock signal line 93 can be formed of mutually different conductive films via an inter-layer insulating film without increasing the complexity of the manufacturing processes. Furthermore, it is possible to form either one of the X-side clock signal line 92 and the X-side inverted clock signal line 93 out of the same film as the lower electrodes 71 instead of the capacitor electrodes 300 or the data lines 6a.

As in a first modification shown in FIG. 9, the power supply line 95 and the video signal lines 91 may be formed out of a conductive film located between the X-side clock signal line 92 and the X-side inverted clock signal line 93 (i.e., the same film as the lower electrodes 71). FIG. 9 is a sectional view showing the first modification, corresponding to FIG. 8 showing the first embodiment. In this case, compared with the cease where the power supply line 95 and the video signal lines 91 are formed out of the same film as either one of the X-side clock signal line 92 and the X-side inverted clock signal line 93, clock noises caused by the X-side clock signal line 92 and the X-side inverted clock signal line 93 can be canceled further. Thus, clock noises on the power supply line and the video signal lines 91 can be further suppressed.

As described above, in the liquid-crystal device according to this embodiment, clock noises or similar negative effects of the X-side clock signal CLX or the X-side inverted clock signal CLXB on other signals such as the video signals VID can be suppressed, so that the quality of image display can be improved. Furthermore, the size of the TFT-array substrate 10 can be reduced, so that the size of the liquid-crystal device can be reduced. Although the description of the embodiment has been given above in the context of the X-side clocks signal CLX and the X-side inverted clock signal CLXB, similarly, other clock signal lines and inverted clock signal lines, such as the Y-side clock signal line and the Y-side inverted clock signal line for supplying the Y-side clock signal and the Y-side inverted clock signal supplied to the scanning-line driving circuit 104, may be formed of conductive films located in mutually different layers via an inter-layer insulating film so as to at least partially overlap each other.

### Second Embodiment

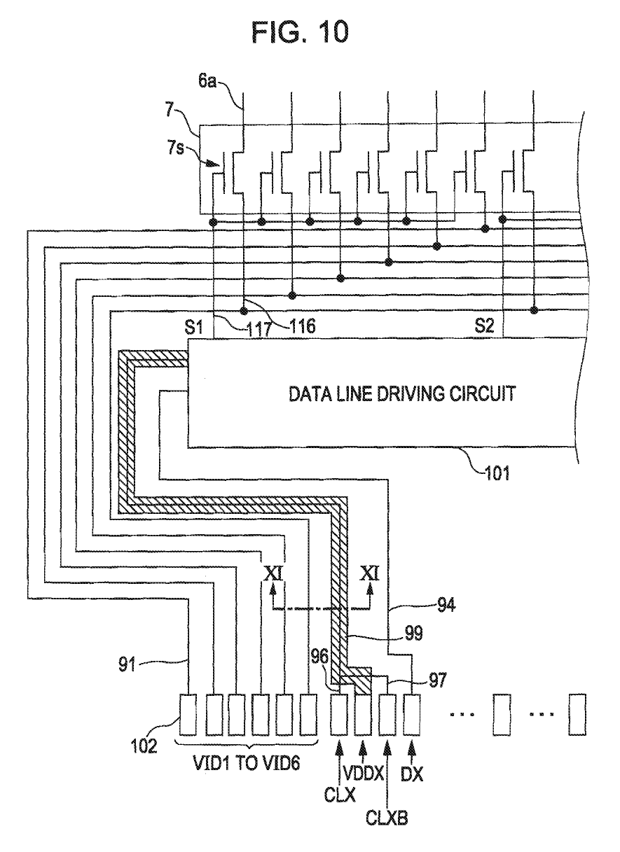

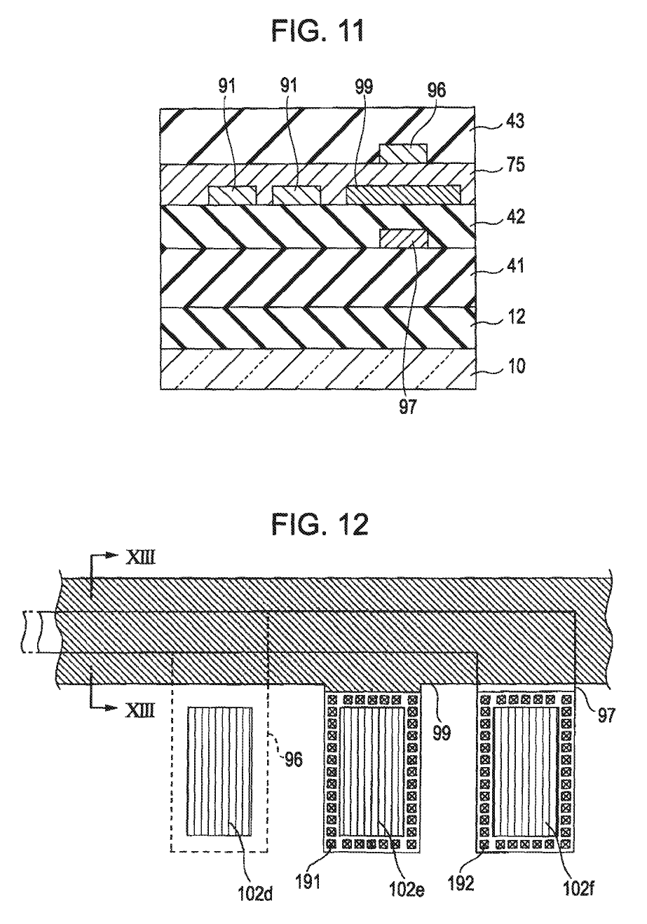

Next, a liquid-crystal device according to a second embodiment will be described with reference to FIGS. 10 to 13. FIG. 10 is a diagram showing the second embodiment, corresponding to FIG. 7 showing the first embodiment. FIG. 11 is a diagram taken along a line XI-XI in FIG. 10. In FIGS. 10 and 11, elements corresponding to those in the first embodiment shown in FIGS. 1 to 8 are designated by the same reference signs, and description thereof will be omitted as appropriate.

As shown in FIG. 10, the liquid-crystal device according to the second embodiment differs from the liquid-crystal device according to the first embodiment in that an X-side clock signal line 96, an X-side inverted clock signal line 97, and a power supply line 99 are provided instead of the X-side clock signal line 92, the X-side inverted clock signal line 93, and the power supply line 95 described above with reference to FIG. 7. The liquid-crystal device according to the second embodiment is otherwise configured substantially the same as the liquid-crystal device according to the first embodiment.

Referring to FIGS. 10 and 11, in this embodiment, the power supply line 99 that serves as a shielding film is provided between the X-side clock signal line 96 and the X-side inverted clock signal line 97 so as to overlap the X-side clock signal line 96 and the X-side inverted clock signal line 97 when viewed in plan on the TFT-array substrate 10.

More specifically, referring to FIG. 11, in this embodiment, the power supply line 99 is located between the layers of the X-side clock signal line 96 and the X-side inverted clock signal line 97 in the lamination structure on the TFT-array substrate 10. That is, the X-side inverted clock signal line 97, the power supply line 99, and the X-side clock signal line 96 are laminated in that order via the second inter-layer insulating film 42 and the dielectric film 75. Alternatively, the X-side inverted clock signal line 97, the power supply line 99, and the X-side clock signal line 96 may be laminated in the opposite order. Furthermore, as shown in FIGS. 10 and 11, in this embodiment, the power supply line 99 is disposed so as to overlap the X-side clock signal line 96 and the X-side inverted clock signal line 97. Thus, the power supply line 99 functions as a shielding film that acts as an electromagnetic shield between the X-side clock signal line 96 and the X-side inverted clock signal line 97. Accordingly, electromagnetic noise caused by the X-side inverted clock signal CLXB on the X-side clock signal line 96 and electromagnetic noise caused by the X-side clock signal CLX on the X-side inverted clock signal line 97 can

Furthermore, in the lamination structure on the TFT-array substrate 10, the X-side clock signal line 96 and the X-side inverted clock signal line 97 are located on the opposite sides of the power supply line 99. Furthermore, the X-side clock signal CLX and the X-side inverted clock signal CLXB have mutually opposite phases (i.e., noises caused by these signals also have substantially opposite phases). Thus, clock noises caused by the X-side clock signal line 96 and the X-side inverted clock signal line 97 can be canceled on the power supply line 99. That is, clock noises on the power supply line 99 can be suppressed or prevented. Accordingly, clock noises caused by the X-side clock signal CLX or the X-side inverted clock signal CLXB on other signal lines 90 in proximity via the power supply line 99 can be suppressed or prevented.

Referring to FIGS. 10 and 11, the X-side clock signal line 96 and the X-side inverted clock signal line 97 are formed so as to have the same width when viewed in plan on the TFT-array substrate 10. That is, the X-side clock signal line 96 and the X-side inverted clock signal line 97 have substantially the same or practically the same width. Furthermore, the X-side clock signal line 96 and the X-side inverted clock signal line 97 are formed so as to overlap each other when viewed in plan on the TFT-array substrate 10. Thus, noises caused by the X-side clock signal line 96 and the X-side inverted clock signal line 97 are canceled more certainly on the power supply line 99. Accordingly, clock noises or similar negative effects caused via the power supply line 99 on other signal lines 90 such as the video signal lines 91 can be suppressed or prevented more certainly. Furthermore, the X-side clock signal line 96 and the X-side inverted clock signal line 97 can be formed in an area of a size substantially the same as the size of an area needed to form one X-side clock signal line 96 (or one X-side inverted clock signal line 97) on the TFT-array substrate 10. Accordingly, the size of the TFT-array substrate 10 can be reduced.

Furthermore, referring to FIG. 11, in this embodiment, the video signal lines 91 are formed out of the same film as the power supply line 99. Thus, similarly to the power supply line 99, noises caused by the clock signal and the inverted clock signal on the X-side clock signal line 96 and the X-side inverted clock signal line 97 having mutually opposite phases can be canceled on the video signal lines 91. Accordingly, clock noises that could occur on the video signal lines 91 clue to the X-side clock signal line 96 and the X-side inverted clock signal line 97 can be suppressed or prevented, so that the quality of image display can be improved.

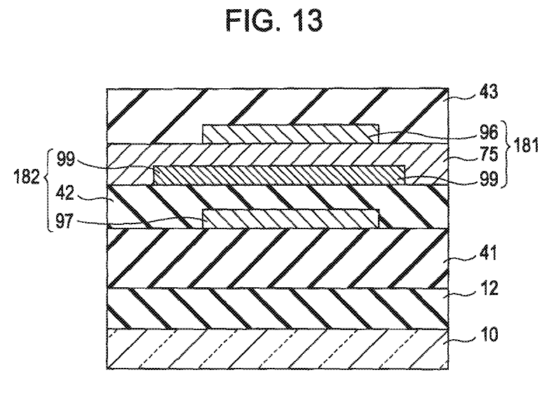

Next, the layout of signal lines in the proximity of the external-circuit connecting terminals will be described with reference to FIGS. 12 and 13. FIG. 12 is a diagram showing the layout of the X-side clock signal line, the X-side inverted clock signal line, and the power supply line in the proximity of the external-circuit connecting terminals. FIG. 13 is a sectional view taken along a line XIII-XIII in FIG. 12. In FIG. 13, individual layers and portions are shown in different scales so that the layers and parts are shown in, sizes recognizable in the figure.

Referring to FIG. 12, the X-side clock signal line 96, the power supply line 99, and the X-side inverted clock signal line 97 are electrically connected to associated external-circuit connecting terminals 102d, 102e, and 102f, respectively. The external-circuit connecting terminals 102d, 102e, and 102f are adjacent to each other. The external-circuit connecting terminals 102d, 102e, and 102f are formed out of the same film that the X-side clock signal line 96 is formed out of, i.e., the same film that the capacitor electrodes 300 are formed out of.

The X-side clock signal line 96 is formed integrally with the external-circuit connecting terminal 102d out of the same film.

The power supply line 99 is electrically connected to the external-circuit connecting terminal 102e via a contact hole 191 formed in the dielectric film 75 in proximity to the external-circuit connecting terminal 102e.

The X-side inverted clock signal line 97 is electrically connected to the external-circuit connecting terminal 102f via a contact hole 192 provided in proximity to the external-circuit connecting terminal 102f and penetrating the dielectric film 75 and the inter-layer insulating film 42.

As shown in FIGS. 12 and 13, in this embodiment, the power supply line 99 is at least partially wider than the X-side clock signal line 96 and the X-side inverted clock signal line 97 when viewed in plan on the TFT-array substrate 10. Thus, electromagnetic interference between the X-side clock signal line 96 and the X-side inverted clock signal line 97 is further suppressed more certainly by the power supply line 99. That is, the performance of the power supply line 99 as a shielding film is improved. Furthermore, the wider line width serves to reduce the resistance of the power supply line 99. Thus, the power supply voltage VDDX can be supplied stably to the data-line driving circuit 101 (refer to FIG. 10) via the power supply

Referring to FIGS. 12 and 13, in this embodiment, the X-side clock signal line 96 and the X-side inverted clock signal line 97 are formed such that the size of ad line capacitor 181 formed by lamination of the X-side clock signal line 96, the dielectric film 75, and the power supply line 99q is substantially the same or practically the same as the size of a line capacitor 189 formed by lamination of the X-side inverted clock signal line 97, the inter-layer insulating film 42, and the power supply line 99. That is, the widths or lengths of the X-side clock signal line 96 and the X-side inverted clock signal line 97 are chosen so as to minimize the difference between the capacitances of the line capacitor 181 and the line capacitor 182. Thus, the level of noise caused on the power supply line 99 by the X-side clock signal line 96 via the line capacitor 181 and the level of noise caused on the power supply line 99 by the X-side inverted clock signal line 97 via the line capacitor 182 can be matched substantially or preferably fully. Accordingly, noises caused by the X-side clock signal line 96 and the X-side inverted clock signal line 97 having mutually opposite phases are canceled more certainly on the power supply line 99. The capacitances of the line capacitors 181 and 182 vary depending on, for example, the materials or thicknesses of the dielectric film 75 and the inter-layer insulating film 42. The widths or lengths of the X-side clock signal line 96 and the X-side inverted clock signal line 97 are chosen so as to minimize the difference between the capacitances of the line capacitors 181 and 182 in consideration of the materials, thicknesses, or other factors. The dielectric film 75 may have different thicknesses between the image display region 10a and the peripheral region. That is, the thickness of the dielectric film 75 may be chosen to be smaller so as to increase the capacitance of the storage capacitors 70 in the image display region 10a while making the thickness of the dielectric film 75 larger in the peripheral region than in the image display region 10a so as to decrease the difference between the capacitances of the line capacitors 181 and 182.

Referring to FIG. 12, in this embodiment, when viewed in plan on the TFT-array substrate 10, the external-circuit connecting terminal 102e electrically connected to the power supply line 99 is located between the external-circuit connecting terminal 102d electrically connected to the X-side clock signal line 96 and the external-circuit connecting terminal 102f electrically connected to the X-side inverted clock signal line 97. Thus, the power supply line 99 can also function as a shielding film in the region where the X-side clock signal line 96 and the X-side inverted clock signal, line 97 are electrically connected to the external-circuit connecting terminals 102. Accordingly, electromagnetic interference between the X-side clock signal CLX and the X-side inverted clock signal CLXB is suppressed more certainly. Furthermore, negative effects caused on other signal lines 90 such as the video signal lines 91 via the power supply line 99 are suppressed or prevented more certainly. The order of the external-circuit connecting terminals to which a clock signal line and an inverted clock signal line such as the X-side clock signal line and the X-side inverted clock signal line are connected may be determined arbitrarily.

### Electronic Apparatus

Next, applications of the liquid-crystal device described above, which is an electro-optical device, to various electronic apparatuses will be described.

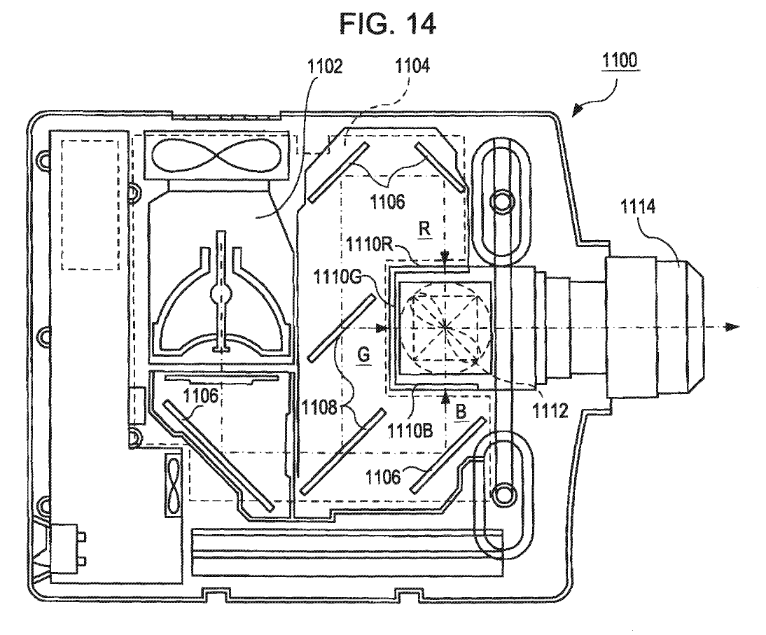

Now, a projector in which the liquid-crystal device is used as a light valve will be described. FIG. 14 is a plan view showing an example configuration of the projector. Referring to FIG. 14, in a projector 1100, a lamp unit 1102 including a white light source, such as a halogen lamp, is provided. Light emitted from the lamp unit 1102 is separated in two three primary colors of RGB by four mirrors 1106 and two dichroic mirrors 1108 provided in a light guide 1104, and the individual components of the three primary colors enter liquid-crystal panels 1110R, 1110G, and 1110B that serve as light valves associated with the respective primary colors.

The liquid-crystal panels 1110R, 1110G, and 1110B are each configured the same as the liquid-crystal device described above, and the liquid-crystal panels 1110R, 1110G, and 1110B are driven according to RGB primary color signals supplied from image-signal processing circuits, respectively. Lights that have been modulated by the liquid-crystal panels 1110R, 1110G, and 1110B enter a dichroic prism 1112 from three directions. The dichroic prism 1112 refracts the R and B light components by 90 degrees while transmitting the G light component straight. Thus, images of the individual color components are combined, whereby a color image is projected on a screen or the like via a projection lens 1114.

Regarding the images displayed with the liquid-crystal panels 1110R, 1110G, and 1110B, the image displayed with the liquid-crystal panel 1110G has to be horizontally reversed to match the images displayed with the liquid-crystal panels 1110R and 1110B.

With the dichroic mirrors 1108, light components of the three primary colors of RGB enter the liquid-crystal panels 1110R, 1110G, and 1110B, color filters need not be provided.

It is to be understood that, without limitation to the electronic apparatus described with reference to FIG. 14, the invention is applicable to various electronic apparatuses. For example, the invention is applicable to mobile personal computers, cellular phones, liquid-crystal television sets, view-finder or direct-view video tape recorders, car navigation units, pagers, electronic notebooks, electronic calculators, word processors, workstations, video phones, point-of-sale (POS) terminals, or apparatuses having touch panels.

Furthermore, as well as the liquid-crystal devices in the embodiments described above, for example, the invention is also applicable to plasma display panels (PDPs), field-emission displays or surface-conduction electron-emitter displays (FEDs or SEDs), organic electroluminescence (EL) displays, digital micromirror devices, or electrophoresis devices.

The invention is not limited to the embodiments described above, and modifications can be made within the gist or the spirit of the invention as understood from the claims and the entire specification. Electro-optical devices involving such modifications and electronic apparatuses including the electro-optical devices also fall within the scope of the invention.

The entire disclosure of Japanese Patent Application No. 2006-045132, filed Feb. 22, 2006 is expressly incorporated by reference herein.

What is claimed is:

1. An electro-optical device comprising:
a substrate;
a plurality of pixels provided on the substrate;
a peripheral circuit for controlling the plurality of pixels, the peripheral circuit being provided in a peripheral region on the substrate, the peripheral region being located in a periphery of a pixel region where the plurality of pixels is provided;
a clock signal line for supplying a clock signal to the peripheral circuit, the clock signal line being provided in the peripheral region on the substrate; and
an inverted clock signal line for supplying an inverted clock signal to the peripheral circuit, the inverted clock signal having a phase opposite to a phase of the clock signal, the inverted clock signal line being provided in the peripheral region on the substrate;
wherein the clock signal line and the inverted clock signal line are individually formed of conductive films located in mutually different layers via an inter-layer insulating film, and the clock signal line and the inverted clock signal line at least partially overlap each other on the substrate.

2. The electro-optical device according to claim 1, further comprising a shielding film provided in the peripheral region, wherein the shielding film at least partially overlap the clock signal line and the inverted clock signal line in a layer between the layer of the clock signal line and the layer of the inverted clock signal line.

3. The electro-optical device according to claim 2, wherein the shielding film is a constant-voltage line for supplying a constant voltage.

4. The electro-optical device according to claim 3, wherein the constant-voltage line is a power supply line for supplying a power supply voltage to the peripheral circuit.

5. The electro-optical device according to claim 3, further comprising an opposing electrode, wherein the pixels include pixel electrodes, the opposing electrode opposes the pixel electrodes, and the constant-voltage line is an opposing-electrode-voltage line for supplying an opposing-electrode voltage to the opposing electrode.

6. The electro-optical device according to claim 3, wherein the constant-voltage line, when viewed in plan on the substrate, has a width that is at least partially larger than either one of or both a width of the clock signal line and a width of the inverted clock signal line.

7. The electro-optical device according to claim 2, wherein the clock signal line and the inverted clock signal line, when viewed in plan on the substrates are formed so as to have equivalent widths and so as to overlap each other.

8. The electro-optical device according to claim 2, wherein either widths or lengths or both widths and lengths of the clock signal line and the inverted clock signal line are adjusted to keep a difference between a capacitance of a first capacitor and a capacitance of a second capacitor small, the first capacitor being formed of a lamination of the clock signal line, a first inter-layer insulating film, and the shielding film, and the second capacitor being formed of a lamination of the inverted clock signal line, a second inter-layer insulating film, and the shielding film.

9. The electro-optical device according to claim 2, further comprising a plurality of external-circuit connecting terminals arrayed in the peripheral region on the substrate, the external-circuit connecting terminals being electrically connected respectively to the clock signal line, the inverted clock signal line, and the shielding film, wherein the external-circuit connecting terminal electrically connected to the shielding film is located between the external-circuit connecting terminals electrically connected respectively to the clock signal line and the inverted clock signal line when viewed in plan on the substrate.

10. The electro-optical device according to claim 2, further comprising a plurality of data lines and a plurality of scanning lines arranged to intersect each other in the pixel region, wherein the pixels are provided in association with intersections of the data lines and the scanning lines, the pixels include storage capacitors on the substrate, each of the storage capacitors being formed of a lamination of a lower electrode, a dielectric film, and an upper electrode in that order, and each of the clock signal line, the inverted clock signal line, and the shielding film is formed of the same film as one of conductive films respectively forming the data lines, the lower electrodes, and the upper electrodes.

11. The electro-optical device according to claim 2, further comprising an image signal line for supplying an image signal to the peripheral circuit, the image signal line being provided in the peripheral region and formed or the same film as the shielding film.

12. An electronic apparatus comprising the electro-optical device according to claim 1.
